(19) United States
(12) Patent Application Publication
(10) Pub. No.: US 2006/0237080 A1
(43) Pub. Date: Oct. 26, 2006

(54) Patterned surfaces and polymeric microstructures within robust microfluidic channels

(76) Inventors: Sangyong Jon, Gwanjgu (KR); Alireza Khademhosseini, Somerville, MA (US); Robert S. Langer, Newton, MA (US); Kahp Yang Suh, Seoul (KR)

Correspondence Address: CHOATE, HALL & STEWART LLP, TWO INTERNATIONAL PLACE, BOSTON, MA, 02110, US

(21) Appl. No.: 11/350,221

(22) Filed: Feb. 8, 2006

Related U.S. Application Data
(60) Provisional application No. 60/652,881, filed on Feb. 15, 2005.

(51) Int. Cl. F16K 11/22

(52) U.S. Cl. 137/883

(57) ABSTRACT

Microfluidic channel. The channel includes a microfluidic mold defining a channel and a substrate including patterned regions. The microfluidic mold is in conformal contact with the substrate to form an irreversible seal. The patterned regions are adapted to immobilize cells.

### RELATED APPLICATIONS

This application claims priority to provisional application Ser. No. 60/652,881 filed Feb. 15, 2005 the contents of which are incorporated herein by reference.

### STATEMENT OF GOVERNMENT INTEREST

The United States Government has rights in this invention under U.S. Army Research Office Contract No. DAAD-19-02-D0002.

### BACKGROUND OF THE INVENTION

This invention relates to fluidic microchannels and more particularly to such microfluidic channels having patterned surfaces and polymeric microstructures in their interior.

Microdevices having microfluidic components hold great promise in the development of improved bioanalytical and diagnostic devices. Microfluidics allows for miniaturization of sample volumes while increasing the throughput and efficiency of analysis. Engineering the surface chemistry and the location of surface molecules within microfluidic channels is important for many potential applications. For example, spatial patterning has been shown to induce fluid mixing, direct fluid flow, and provide means of generating functional microfluidic components such as valves. In addition, controlling the location of proteins and cells within a microfluidic channel is important for the development of miniaturized analytical devices and multi-step bioreactors. One application is high throughput screening. Another application is for performing fundamental studies of cell biology and fluid mechanics.

Currently, the most commonly used approaches to pattern within microchannels are laminar flow patterning and photolithography. These techniques have been used to pattern cells, proteins, or hydrogels, direct the flow of liquids, and etch or build microstructures within microchannels. Despite the success of these approaches to control the surface properties of microchannels, there are potential limitations. For example, laminar flow patterning, a simple approach to pattern within microfluidic channels, is limited to generating geometrical patterns in the shape of the laminarly flowing streams. In addition, photolithography, a useful tool for many emerging applications, has limitations due to the potential cytotoxicity of the photoinitiator, the need for specialized equipment, and the difficulty in patterning the surface without modifying the surface topography. Therefore, the development of simple and direct techniques for patterning the surface of microfluidic channels will be a benefit.

Soft lithographic approaches such as microcontact printing, micromolding, and capillary force lithography have served as inexpensive, convenient and scalable tools for patterning surfaces. Despite these attractive traits, the merger of soft lithographic patterning approaches and microfluidics has not been realized. To pattern microfluidic channels using soft lithography, the surface patterning must occur prior to the attachment of a poly(dimethylsiloxane) (PDMS) mold to a substrate. However, the formation of an irreversible seal between the PDMS mold with the substrate requires oxygen plasma treatment which can destroy the patterns. To overcome exposure to oxygen plasma, patterned membranes (such as polycarbonate membranes) have been sandwiched between two plasma treated PDMS surfaces. This approach, however, is time consuming and requires multiple steps. Furthermore, the presence of a non-adherent polycarbonate membrane may affect the robustness of the channels. It is therefore desirable to have a technique that can be used with multiple soft lithographic patterning processes to directly pattern the substrate of microfluidic channels.

### SUMMARY OF THE INVENTION

In one aspect, the invention is a microfluidic channel including a microfluidic mold defining a channel and a substrate including patterned regions. The microfluidic mold is in conformal contact with the substrate to form an irreversible seal. In a preferred embodiment of this aspect of the invention, the patterned regions comprise polymeric regions in the range of 1 to 500 nm in height. In another embodiment, the pattern regions comprise microstructures adapted to capture and immobilize cells, proteins, viruses, and other biological species. In this embodiment, the patterned regions may be exposed to the substrate or not exposed to the substrate. It is preferred that the microstructures be formed of a non-biofouling PEG-based copolymer or the polysaccharide hyaluronic acid (HA). A suitable PEG-based polymer is poly(TMSMA-r-PEGMA). Suitable microstructures have a height in the range of 0.1-50 μm.

Yet another aspect of the invention is a method of making a patterned microfluidic channel including coating a substrate with a polymer and conformal contacting a patterned stamp with the polymer coated substrate to create a patterned substrate. Exposed regions of the substrate are treated with oxygen plasma and thereafter the patterned stamp is removed. A microfluidic channel is positioned on the patterned substrate so that it is covalently bonded to the substrate.

Another aspect of the invention is a method for making a patterned microfluidic channel including coating a patterned stamp with a polymer and conformal contacting the coated patterned stamp with a substrate to create a patterned substrate. Exposed regions of the substrate are treated with oxygen plasma followed by removing the patterned stamp and positioning a microfluidic channel on the patterned substrate so that it is covalently bonded to the substrate.

Yet another aspect of the invention is a method for making microstructures inside microchannels including spreading a pre-polymer solution on a substrate and contacting a patterned stamp onto the substrate. The pre-polymer solution is cross-linked and the substrate is cleaned beyond the patterned stamp. The patterned stamp is removed leaving patterns that do not expose the substrate and a microfluidic mold is aligned on the patterned substrate and bonded to the substrate to create a microfluidic channel.

Yet another aspect of the invention is a method for making microstructures inside microchannels including spreading a pre-polymer solution on a patterned stamp and contacting the stamp onto a substrate. The pre-polymer solution is cross-linked followed by cleaning the substrate beyond the patterned stamp. The patterned stamp is removed leaving patterns that expose the substrate and a microfluidic mold is aligned on the patterned substrate and bonded to it to create a microfluidic channel.

In preferred embodiments of the invention, the substrate is selected from the group consisting of glass, SiO₂, polystyrene, silicon wafers, and other metal oxide-based substrates. A suitable mold is made of poly(dimethylsiloxane) (PDMS).

### BRIEF DESCRIPTION OF THE DRAWING

FIG. 1 is a schematic diagram illustrating molding and microcontact printing aspects for making the structures according to the invention.

FIG. 2a is a fluorescent image of unprotected (left) versus protected (right) sections of molded HA.

FIG. 2b is a fluorescent image of unprotected (left) versus protected (right) sections of molded poly(TMSMA-r-PEGMA).

FIG. 2c is a fluorescent image of unprotected (left) versus protected (right) sections of microcontact printed poly(TMSMA-r-PEGMA).

FIG. 3a is a light micrograph of patterned microfluidic channels patterned with the PEG-based copolymer, poly(TMSMA-r-PEGMA).

FIG. 3b is a fluorescent image of patterned microfluidic channels patterned with the PEG-based copolymer. The substrate was stained with Texas red labeled bovine serum albumin (TR-BSA).

FIG. 3c is a fluorescent image of patterned microfluidic channels patterned with the PEG-based copolymer and stained with fibronectin (FN).

FIG. 3d is a light micrograph of patterned microfluidic channels patterned with HA.

FIG. 3e is a fluorescent image of a patterned microfluidic channel patterned with HA and stained with FITC labeled bovine serum albumin (FITC-BSA).

FIG. 3f is a fluorescent image of a patterned microfluidic channel patterned with HA and stained with FN.

FIG. 4a is a fluorescent image of a microfluidic channel in which laminar flow was used to immobilize two different proteins on the patterned substrate. TR-BSA and FITC-BSA flowed through a channel resulting in the formation of patches on various sides of the channel.

FIG. 4b is a fluorescent image in which individual patterns were coated with TR-BSA and FITC-BSA.

FIG. 5a is a light micrograph of cells entering a microfluidic channel as spherical cell suspensions of NIH-3T3 fibroblasts.

FIG. 5b is a light micrograph after six hours in a microfluidic channel patterned with poly(TMSMA-r-PEGMA).

FIG. 5c is a light micrograph after six hours for channels patterned with HA.

FIG. 5d is a light micrograph showing fibroblast adhesion to a non-patterned microchannel.

FIG. 6a is a light micrograph image of NIH-3T3 fibroblasts patterned on microfluidic channels that had been treated with ethidium homodimer and calcein AM.

FIG. 6b is a fluorescent image of the fibroblasts in FIG. 6a.

FIG. 6c is a light micrograph of NIH-3T3 cells that were lysed by a pulse of triton-x and subsequently treated with ethidium homodimer and calcein AM.

FIG. 6d is a fluorescent image of the fibroblasts of FIG. 6c.

FIG. 7 is a schematic illustration of a fabrication method according to an aspect of the invention for making exposed and non-exposed microstructures inside microchannels.

FIG. 8a is a scanning electron micrograph of molded PEG lanes with an exposed substrate.

FIG. 8b is a scanning electron micrograph of microwells with a non-exposed substrate.

FIG. 8c is a scanning electron micrograph showing a circular microwell approximately 25 μm in height.

FIG. 8d is a scanning electron micrograph of a pattern of molded microwells.

FIG. 9a is a light micrograph image of microstructures with non-exposed underlying substrates.

FIG. 9b is a fluorescent image of microstructures with non-exposed underlying substrates.

FIG. 9c is a light image of microstructures with exposed underlying substrates.

FIG. 9d is a fluorescent image of microstructures with exposed underlying substrates.

FIG. 10a is an image illustrating NIH-3T3 cell adhesion on a non-exposed PEG microwell.

FIG. 10b is an image showing NIH-3T3 cell adhesion on exposed PEG microwells.

FIG. 11a is a micrograph showing cells flowing through microchannels docked within 100 μm microwells.

FIG. 11b is a micrograph showing cells flowing through perpendicular lanes.

FIG. 11c is a micrograph showing cells docked within grids.

FIG. 12a is a micrograph showing NIH-3T3 cells immobilized within PEG microwells.

FIG. 12b is a micrograph of cells with live-dead staining.

FIG. 12c is a micrograph showing murine embryonic stem cell patterning within a non-exposed microfluidic channel.

FIG. 12d is a micrograph showing SSEA staining within non-exposed microfluidic channels.

FIG. 13a is a photomicrograph at low magnification showing NIH-3T3 cells captured and adhered on the channels with FN coated substrates.

FIG. 13b is a photomicrograph at high magnification of the NIH-3T3 cells shown in FIG. 13a.

### DESCRIPTION OF THE PREFERRED EMBODIMENTS

Polymeric patterning and microstructures can be used to capture and immobilize cells within particular regions of microfluidic channels. The patterns can be in the form of microstructures within microfluidic channels that enable cells to adhere within particular regions of a channel in non-biofouling microstructures with exposed substrates. The cells in such regions are shear protected allowing for easy docking and subsequent analysis. Novel techniques to fabricate robust microchannels with precise control over the spatial properties of the substrate are discussed below. The approach set forth herein can be used to fabricate surface patterns with or without substantial topographical heights. An important aspect of the invention is that excellent control can be obtained on the topographical features within microfluidic channels with or without exposure of the underlying substrate. The approach disclosed herein is based on patterning a substrate using either microcontact printing or micromolding prior to aligning and attaching a microfluidic mold on a substrate. An important feature of the approach of the invention is that the patterned regions are protected from oxygen plasma by controlling the dimensions of the stamp used in the process and by leaving the stamp in place during the plasma treatment process.

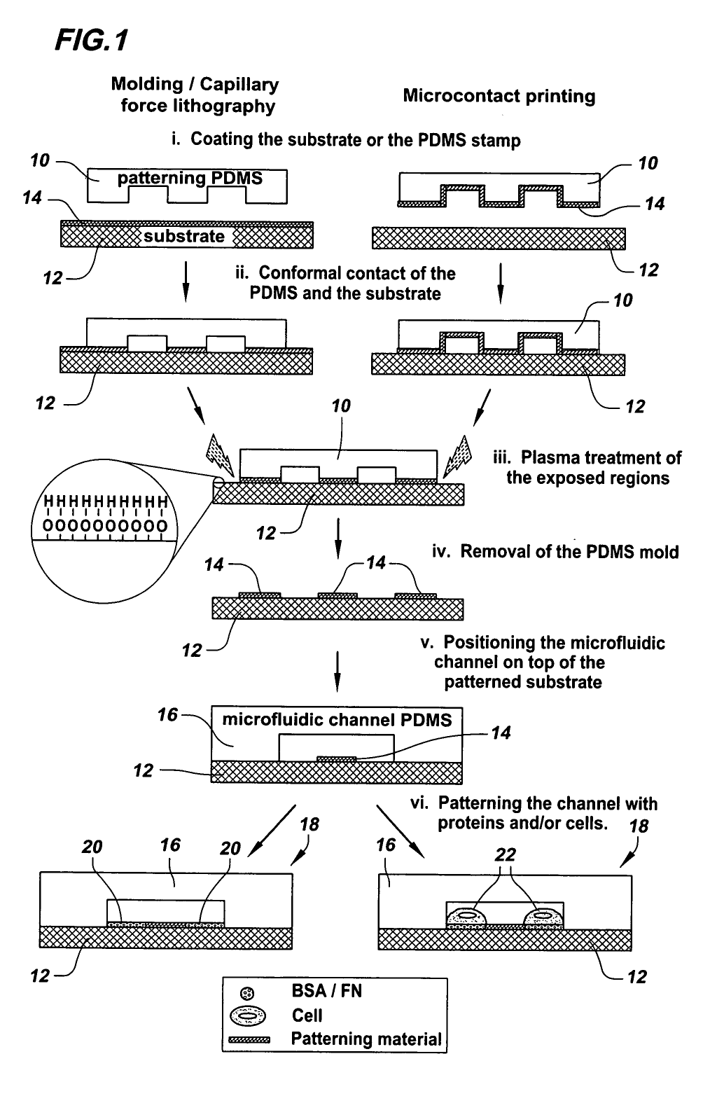

A first aspect of the invention is shown in FIG. 1. A patterned stamp 10 may be made of poly(dimethylsiloxane) (PDMS). A substrate 12 is coated with a polymer 14. A suitable substrate 12 is made from glass, SiO₂, polystyrene, or silicon wafers. A suitable polymer 14 is poly(ethylene glycol) (PEG) or polysaccharide hyaluronic acid (HA). As shown in FIG. 1, the polymer 14 may be placed on the substrate 12 or on the patterned stamp 10. The patterned stamp 10 is then brought into conformal contact with the substrate 12. Exposed regions of the substrate 12 beyond the stamp 10 are treated with oxygen plasma. The oxygen plasma treatment prepares the surface for subsequent covalent bonding.

After plasma treatment, the stamp 10 is removed leaving a pattern in the polymer 14. Thereafter, a microfluidic channel 16 preferably made of PDMS is positioned on the substrate 12 on top of the polymer pattern 14. A completed microfluidic channel 18 allows for the selective adsorption of fibronectin (FN) and bovine serum albumin (BSA) onto the patterned microfluidic channel as shown at 20. Cells 22 can then be patterned to make, for example, cell-based biosensors and bioreactors.

PDMS molds were fabricated by curing a prepolymer on silicon masters patterned with SU-8 photoresist. The masters used for patterning had protruding cylindrical features (ranging in diameter from 15 to 150 μm), which resulted in PDMS replicas with the opposite sense (referred to as PDMS stamps). The masters used for microfluidics had protruding features with the impression of microfluidic channels (ranging from 50 to 600 μm in width and ˜80 μm in height) (referred to as PDMS molds). To cure the PDMS prepolymer, a mixture of 10:1 silicon elastomer and a curing agent was poured on the master and placed at 70° C. for 2 h. The PDMS replica was then peeled from the silicon wafer and cut into narrow strips (˜0.3 cm×3 cm). These strips were sufficiently large to allow for the formation of patterns, while being small enough to allow for the major portion of the glass slide to be plasma cleaned.

We generated patterned surfaces using microcontact printing and molding to demonstrate the versatility of the approach to pattern microchannels with various soft lithographic techniques. HA films were prepared by spin-coating (model CB15, Headaway Research Inc.) a solution containing 5 mg of HA/mL of distilled water onto silicon dioxide substrates (glass slides or wafers) at 1500 rpm for 15 s. Immediately after coating, a plasma-cleaned PDMS stamp with negative features was brought into conformal contact with the substrate and left to be dried for 12 h at room temperature. The patterned surfaces were then washed with PBS to remove the nonchemisorbed HA from the surface.

To synthesize poly(TMSMA-r-PEGMA), PEGMA, TMSMA, and AIBN were dissolved in tetrahydrofuran at a molar ratio of 1.0:1.0:0.01, degassed for 20 min, and reacted using free-radical polymerization at 70° C. for 24 h. The solvent was then evaporated, leaving behind a viscous liquid. The synthesized poly(TMSMA-r-PEGMA) was used to pattern surfaces using both micromolding and microcontact printing. To pattern using micromolding, glass slides were plasma cleaned for 3 min and the poly(TMSMA-r-PEGMA) solution (10 mg/mL in MeOH) was spin-coated onto each glass slide (1000 rpm for 10 s). A PDMS stamp was then immediately placed in conformal contact with the spin-coated surface and left undisturbed for 1 h. To pattern the PEG-based copolymer using microcontact printing, the PDMS stamp was plasma cleaned for 3 min and subsequently a few drops of a solution of 10 mg/mL polymer in MeOH was placed on the stamp. To generate a uniform polymer coating, the PDMS stamps was either spin coated at 1000 rpm for 10 s or air-dried until a thin film remained. The pattern on the PDMS stamp was then transferred onto the substrate by firmly pressing the stamp and the substrate together. All patterns were cured at 110° C. for 15 minutes.

To complete the device fabrication, a second PDMS mold with the features of the microfluidic channel and a patterned glass slide were plasma cleaned for 15-300 s (60 W, PDC-32G, Harrick Scientific, Ossining, N.Y.), without disturbing the PDMS stamp used for patterning (i.e., in conformal contact with the substrate). After plasma treatment, the first PDMS stamp was peeled from the substrate and the microfluidic channel PDMS mold was brought in conformal contact with the substrate and firmly pressed to form an irreversible seal. The microfluidic molds were aligned on the patterns either manually or after the addition of a drop of anhydrous ethanol (to assist in the alignment by delaying the irreversible binding) under the microscope. Fluids were driven through the channels using a SP200i syringe pump (World Precision Instruments, Sarasota, Fla.) that was connected to the device using polyethylene tubing (BD, Franklin Lakes, N.J.).

FITC-BSA, TR-BSA, and FN were dissolved in PBS (pH 7.4) at concentrations of 50, 50, and 20 μg/mL, respectively. To test for adhesion of protein within the patterned microfluidic channels, the primary protein was pumped through the microchannels for 30 min at a flow rate of 5 μL/min. For FN staining, a solution of anti-FN antibody was run through the channel for an additional 45 min, followed by 1 h of FITC-labeled anti-rabbit secondary antibody. Protein patterns on patterned glass slides were generated by evenly distributing a few drops of the protein solution of the surfaces, storing the samples at room temperature for 30 min, and then rinsing the patterns with PBS. All patterned surfaces were analyzed using an inverted fluorescent microscope (Axiovert 200, Zeiss). All protein-staining experiments were done in triplicate to ensure that multiple pictures were captured. Fluorescent images of various samples were then taken and quantified using NIH-Scion Image viewer. Blank glass slides analyzed under the same light exposure were used as background controls.

NIH-3T3 murine embryonic fibroblasts were maintained in DMEM supplemented with 10% FBS at 37° C. and 5% CO₂ environment. For cell attachment experiments, a solution of 20 μg/mL FN in PBS was flowed through the channel for 15 min followed by a suspension of cells (˜(1-5)×10⁷ cells/mL) in medium containing serum at a flow rate of 5 μL/min. Once the cells were inside the channel, the fluid flow was redirected by closing the outlet of the channel and redirecting the fluid through a Y connector. Cells were maintained in the channels for at least 3 h. Periodically, the cells were perfused with the medium at low flow rates (˜0.1 mL/min) to ensure a constant supply of oxygen and nutrients. Once the cells adhered, the medium flow rate was increased to 1-3 μL/min and maintained throughout the experiment. The experiments involving cells and microfluidics were performed on an Axiovert 200 microscope (Zeiss, Germany) with an environmental chamber designed to maintain the temperature at 37° C. and 5% CO₂. The resulting cell patterns were directly examined under a phase-contrast microscope after removing the nonadhered cells by flowing PBS through the channel.

Calcein-AM and ethidium homodimer were dissolved at a concentration of 1 μg/mL in PBS. Once the cells adhered and excess cells were washed, the calcein-AM and ethidium homodimer were flowed through the channel for 30 min at a flow rate of 3 μg/mL in PBS. Once the cells adhered and excess cells were washed, the calcein-AM and ethidium homodimer were flowed through the channel for 30 min at a flow rate of 3 μL/min. For experiments in which the cells were lysed, a solution of 0.1% Triton-X in PBS flowed through the channel for 5 min at 3 μL/min. The cells were then stained with calcein-AM and ethidium homodimer as described above and analyzed under a fluorescent microscope.

Although the direct placement of a microfluidic mold on a glass slide, without any chemical modification, could be used to make channels with patterned substrates, the resulting channels can only be operated under low pressures, which would limit the range of fluid flows and the minimum size of the channels. To generate robust microchannels, the surfaces must be treated with oxygen plasma, which generates surface hydroxyl groups that can form covalent bonds between two plasma-treated surfaces. However, the oxidation reaction associated with plasma treatment can potentially destroy the micropatterns. We hypothesized that surface patterns could be protected against plasma treatment by preventing their exposure to oxygen plasma. In our approach, the patterns were protected from oxidation by leaving the PDMS stamp intact during the plasma treatment. To ensure that only a small region of the substrate was protected while the remainder of the substrate was treated, the size of the PDMS stamp was limited to dimensions slightly greater than the channel. Thus, a small section of the substrate was patterned and remained protected while the rest of the substrate facilitated irreversible binding to the microfluidic mold.

Micropatterns were fabricated using both microcontact printing and molding techniques. The microcontact printed patterns were formed by transferring the polymer from the PDMS stamp to the substrate by direct contact. A thin layer of the PEG-based polymer was deposited on the PDMS stamp, and the pattern was subsequently transferred to the substrate by firmly pressing the stamp onto the substrate. The molding patterns were generated by capillary force lithography. In this approach, a thin film was spin coated onto the substrate, and a PDMS stamp was subsequently brought into conformal contact with the surface and left until dried.

The molding occurred as a result of capillary depression within the void spaces (i.e., repulsion of the hydrophilic polymer solution from the PDMS stamp) as well as the hydrodynamic forces at the contact regions. Therefore, a thin film remained at the contact regions while the void regions dewetted from the surface to expose the substrate.

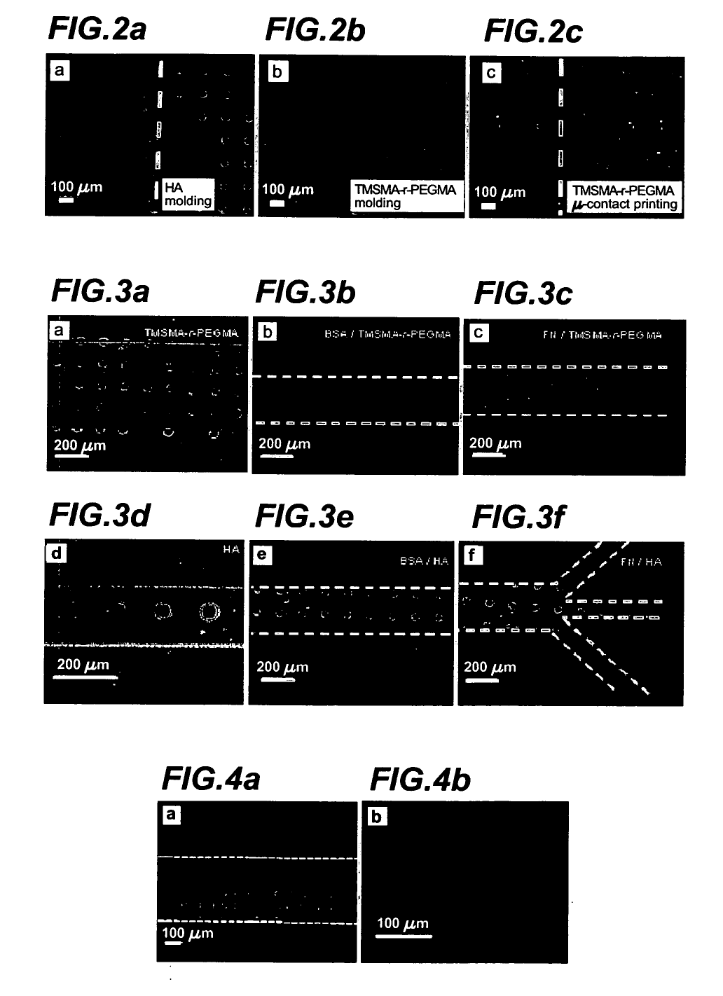

To directly analyze the stability of the plasma-treated patterns as well as the protective effects of PDMS, stamps that were used to pattern the surface were gently cut into two pieces while conformal contact with the patterns was maintained. One of the two pieces was then peeled from the surface while the other was left on the glass slide. The glass slide with PDMS stamp was then plasma cleaned for various durations and subsequently stained with FITC-BSA. For HA patterns, after 15 s of exposure to oxygen plasma, the patterns became distorted as small sections of the patterns detached from the surface, and by 45 s of exposure, the patterns had deteriorated further with many regions peeling from the surface (FIG. 2A (left)). Similarly, poly(TMSMA-r-PEGMA) patterns that were made using both molding and microcontact printing deteriorated after 15 s and were completely destroyed after 45 s (FIG. 2B, C (left)). Interestingly, we did not observe a significant difference between the deterioration rate of the microcontact printed and molded PEG-copolymer patterns. As illustrated, protected patterns that were exposed to 45 s of plasma treatment did not lose their pattern fidelity (FIG. 2 (right)). Furthermore, both HA- and PEG-based patterns remained unaffected even after being plasma treated for 6 min (data not shown). The patterns did not degrade when placed at low pressures similar to the conditions used for plasma treatment (200 millibars for up to 6 min), suggesting that the patterns were destroyed due to plasma treatment and not because of the vacuum associated with the plasma-cleaning process. In these experiments, molds with negative features were used (i.e., features sticking in), and the patterns were generated through the formation of thin polymeric monolayers between the contact regions of the PDMS and the substrate. Therefore, these results suggest that polymeric films formed between the contacted regions remain protected, indicating that the approach could be used for more commonly used techniques such as PEG self-assembled monolayers and other forms of microcontact printing. Furthermore, we anticipate that molded structures within the void regions of a PDMS stamp would also be protected from the oxygen plasma (as long as it was sealed from the surroundings and not exposed to the oxygen plasma), suggesting that the approach may be used in conjunction with other molding and photo-cross-linking techniques.

We utilized the oxygen plasma protective features of the PDMS stamp to design an approach to fabricate stable microchannels with patterned substrates. In this approach, the polymers were patterned on oxide-based substrates. Unless noted otherwise, we patterned the channels using microcontact printed PEG-based copolymers or molded HA. After patterning, the substrate was plasma cleaned while maintaining the conformal contact between the PDMS stamp (used for patterning) and the glass slide. The PDMS stamp was then removed and a microfluidic channel was then aligned on the patterns and irreversibly attached to the substrate.

As shown in the light microscope images in FIG. 3, channels were fabricated with PEG-based copolymer (FIG. 3A) or HA (FIG. 3D) patterns. The pattern edges in these images were clearly visible, which provided an easy way to detect pattern fidelity and to align the channel. To characterize the non-biofouling properties of these patterned microfluidic channels, protein adsorption experiments were performed by flowing FITC-BSA or TR-BSA or FN through the channels. Fluorescent images in FIG. 3 are representative protein-patterning images for various tested conditions. The fluorescence was limited to the exposed regions, indicating that proteins attached directly to the patterns. Both PEG-based polymer and HA showed excellent protein resistance for BSA (95±2 and 97±3%, respectively) and FN (96±3 and 95±3% relative to bare glass) within the channels. These values were not significantly different from the protein adhesion results obtained immediately after patterning, indicating that the additional steps involved in fabrication and the shear stress associated with the flowing fluid did not alter the intrinsic non-biofouling properties of the patterned films.

In addition, to control the adsorption of multiple proteins to various regions of an exposed substrate, we used laminar flow patterning. It was demonstrated that laminar flow of multiple proteins could be used to generate patterned arrays of proteins within channels. As can be seen from FIG. 4A, TR-BSA and FITC-BSA were adsorbed onto the various patterns within the channel. The adsorption of multiple proteins within single channels could be potentially useful for fabricating arrays of immunoassays for biosensors. Furthermore, individual patterns can be coated with two (or more) different proteins as illustrated in FIG. 4B. In this case, TR-BSA and FITC-BSA flowed side by side in a microfluidic channel directly above an exposed pattern being aligned at the region between the two streams. The spatial patterning of multiple proteins within the individual islands could be potentially useful in studying the effects of spatial organization of multiple extracellular matrix components on cell behavior such as asymmetric cell division.

To examine the potential of the patterned microfluidic channels for generating cellular arrays within microfluidic channels, we fabricated patterned microfluidic channels using both HA- and PEG-based copolymer. Prior to cell seeding, a solution of FN flowed through the channels for 15 min. As previously shown, the FN selectively adsorbs to the exposed regions forming strong anchoring sites for cells. NIH-3T3 cells were then flowed in the channels. Once the cells were inside the channel, the outlet of the channel was closed and the fluid flow was redirected through a Y-connector that joined the polyethylene tubing from the syringe pump to the tubing from the microfluidic device. We found the use of this Y-connector was critical in maintaining the pressure within the channel since at lower pressures bubbles spontaneously formed and peeled the cells from the surface. A cell suspension of 5×10⁷ cells/mL was found to be optimum to form cellular monolayers or arrays. Concentrations of <1×10⁷ cells/mL did not form confluent cell layers while concentrations of >1×10⁸ cells/mL clogged the channels.

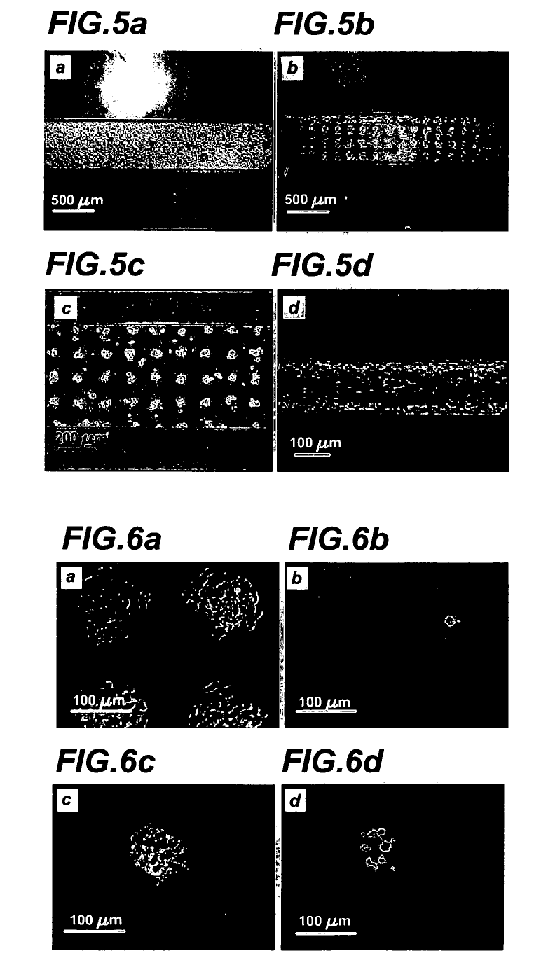

The morphology of the cells within the microchannels resembled that of the cells plated under normal tissue culture conditions. The cells entered the channels as spherical cell suspensions (FIG. 5A) and started to spread on the surface within 2 h. At this time, the nonadherent cells were removed by gentle fluid flow, leaving behind partially adhered cells that fully adhered by 6 h. Cells adhered to the FN-coated regions on patterns generated from HA- or PEG-based copolymer (FIG. 5B, C); while inside nonpatterned channels, cells formed a confluent monolayer (FIG. 5D). Once adhered in the channels, the cells did not stain for PI or Trypan blue dyes, indicating that they remained viable. These results indicate that the cells could be patterned within microfluidic channels at high confluency and with high precision. We have maintained these cells within the microfluidic channels for 24 h, indicating that they can be maintained for durations that are relevant for bioanalytical and biosensing applications. Furthermore, the use of HA as a patterning material may potentially lead to the generation of patterned cocultures within microchannels using HA and poly(L-lysine), which could enhance the functionality of the cells by controlling their cell-cell interactions.

Recently, the ability to perform cellular reactions within microfluidic channels has been proposed as a method of fabricating biosensors, improved systems to study cellular behavior, and microreactors for biochemical synthesis. This is particularly important as mammalian cells, capable of detecting toxins and pathogens or capable of performing chemical reactions with fast response times are engineered.

To analyze the potential of this patterning approach for various analytical applications, we tested the ability of the immobilized cells to carry out enzymatic reactions using ethidium homodimer and calcein-AM molecules. The membrane-permeable calcein-AM enters all cells and is enzymatically converted to green fluorescent calcein in the cytoplasm. Cells with an intact plasma membrane (viable cells) retain calcein, and thus fluoresce green. Only cells with a compromised plasma membrane (dead cells) take up ethidium homodimer (seen as a red dye). Thus, we were able to analyze the viability and functionality of these cells within the channels. As illustrated in FIG. 6A, NIH 3T3 cells remained viable and were also capable of performing enzymatic reactions (>98% of the cells stained only as green). To examine the potential of releasing the contents of the cells, a solution of Triton-X, a common surfactant used to permeabilize cell membranes in culture, flowed through the channel. This was followed by a solution of calcein-AM/ethidium homodimer, after which the cells were analyzed under a fluorescent microscope. As shown in FIG. 6D, 58±8% of the cells that were treated with Triton-X were lysed as indicated by the permeation of ethidium homodimer across the membrane (red color). Interestingly, cells that were closer to the center of cellular aggregates remained viable, suggesting that the mass-transfer limitations associated with the diffusion of Triton-X to the center of these aggregates may have protected these cells.

A question arises here about the potential limitations of this approach with respect to the minimum size and the geometrical shape of the fabricated channel. The main limitation with the technique is the inability to precisely place the PDMS mold on the patterned substrate. However, we believe that the application of the process to smaller channels is technically feasible by aligning small channels (i.e., <10 μm) under the microscope through the use of a micromanipulator. In addition, appropriately designed PDMS stamps could allow the fabrication of complex microchannel arrays at smaller length scales (<10 μm). These PDMS stamps could have fabricated void regions between the stamp and the substrate that are exposed to the surroundings, allowing for plasma oxidation of the desired regions without the need to cut the stamps into smaller pieces.

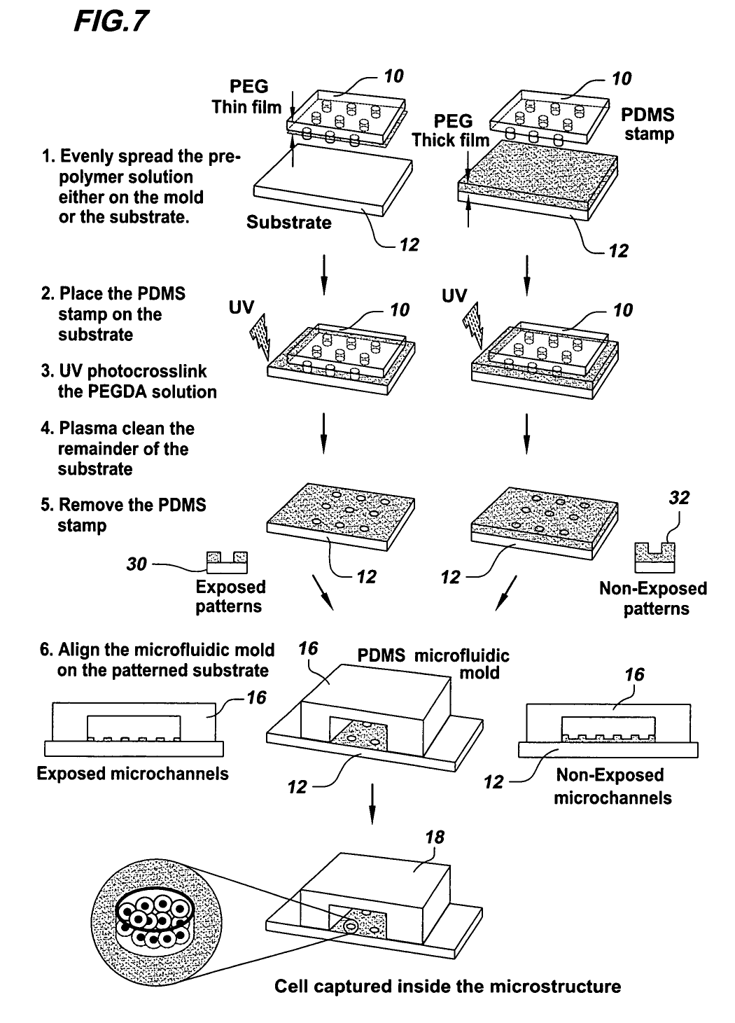

Another technique for making the patterned microfluidic channels will now be discussed in conjunction with FIG. 7. As with the embodiment of FIG. 1, a PDMS stamp 10 is patterned. A pre-polymer solution is spread either on the stamp 10 or on the substrate 12. The stamp 10 is then placed on the substrate 12 and ultraviolet light is used to photo-crosslink the PEGDA solution. The portion of the substrate beyond the stamp 10 is cleaned with a plasma and thereafter the stamp 10 is removed. The patterns are either exposed 30 or non-exposed 32. A microfluidic mold 16 is aligned on the patterned substrate and is irreversibly bonded to the substrate 12. The resulting microfluidic channel 18 can be used to capture cells inside.

PDMS molds were fabricated by curing the pre-polymer on silicon masters patterned with SU-8 photoresist. The masters used for patterning had receding cylindrical features (ranging from 15 to 150 μm in diameter), 100 μm lanes or larger grids which resulted in PDMS replicas with the opposite sense. The masters used for microfluidics had protruding features with the impression of microfluidic channels (ranging from 50 to 800 μm in width and ˜80 μm in height). To cure the PDMS prepolymer, a mixture of 10:1 silicon elastomer and the curing agent was poured on the master and placed at 70° C. for 2 h. The PDMS stamps (i.e. used for patterning) and the microfluidic molds were then peeled from the masters and cut. The PDMS stamps were cut into narrow strips (˜0.3 cm×2 cm) that were sufficiently large to pattern the entire width of the channels, while allowing the rest of the substrate to be plasma cleaned.

Prior to patterning, glass slides were plasma treated for 2 min, immersed in a solution of 30% H₂O₂ and H₂SO₄ (3:1 ratio) for 5 min and washed in DiH₂O. The slides were then immersed in a 1 mM solution of 3-(trichlorosilyl)propyl methacrylate (TPM) for 5 min to enhance the adhesion of PEG microstructures to the surface and washed with a mixture of heptane/carbon tetrachloride (80/20 v/v) and DiH₂O.

To perform scanning electron microscopy (JEOL 6320FV) samples were mounted onto aluminium stages and sputter coated with gold to a thickness of 200 Å and analyzed at a working distance of 20 mm.

TR-BSA was dissolved in PBS (pH=7.4) at 100 μg mL⁻¹. To test for substrate exposure through protein adhesion, a few drops of the protein solution were evenly distributed onto the patterned substrates and incubated at room temperature for 45 min. All patterned surfaces were then washed and analyzed using an inverted fluorescent microscope (Axiovert 200, Zeiss).

The microstructures were made using a solution of 99.5 wt. % PEGDM (MW 330, 550, or 50% 1000 dissolved in PBS) and 0.5 wt. % of a water soluble photoinitiator 2-hydroxy-2-methyl propiophenone photoinitiator. To fabricate the exposed and non-exposed microstructures on the substrate we used a technique called capillary force lithography. Two different approaches were used to generate the substrates with varying features as shown in FIG. 7. To generate features with non-exposed substrates, a few drops of the PEG polymer were evenly distributed onto the substrate, whereas to generate features with the exposed substrate a few drops of the pre-polymer were evenly spread on the PDMS stamp. The PDMS mold was then placed directly on the polymer film and exposed to 365 nm, 300 mW cm⁻² UV light (EFOS Ultracure 100ss Plus, UV spot lamp, Mississauga, Ontario) for 30 s.

Once the microstructures were fabricated, the devices were completed by plasma cleaning the slide (without disturbing the PDMS stamp) and the microfluidic mold for 2 min (60 W, PDC-32G, Harrick Scientific, Ossining, N.Y.). After plasma treatment, the PDMS stamp was peeled from the substrate and the microfluidic mold was aligned and brought in conformal contact with the substrate and firmly pressed to form an irreversible seal. In some experiments the devices were further supported by clamping the mold to the substrate.

Fluids were driven through the channels using a SP200i syringe pump (World Precision Instruments, Sarasota, Fla.) that was connected to the device using polyethylene tubing. Transitions between different injections were facilitated with a Y connector that was used to redirect bubbles that were formed by changing the inlet solution.

All experiments involving cells inside the channels were carried out in a 37° C., 5% CO₂ environment chamber (Zeiss, Germany) and visualized under a fluorescent microscope. To immobilize cells within the microstructures, cells were trypsinized and resuspended in medium at a concentration of ˜2×10⁷ cells mL⁻¹ and kept on ice. The channel was first treated with ethanol (95%) to clear potential air bubbles, followed by PBS for 10 min at a flow rate of 1 μL min⁻¹. For cell adhesion studies, fibronectin (25 μg mL⁻¹) was then flowed in the channel for 15 min.

Cells were introduced into the channel and the flow was stopped to sediment the cells into microwells. After 10 min the flow was restarted and maintained at 1 μL min⁻¹.

To analyze cellular viability, a live/dead assay was performed by flowing ethidium homodimer and calcein AM dissolved at 1 μg mL⁻¹ in DMEM containing 10% FBS through the channel for 20 min. Staining of ES cells was performed by flowing MC-480/SSEA-1 (diluted 1:10 in a PBS solution with 1% BSA) for 20 min and then phycoerythrin conjugated goat anti-mouse IgM (diluted at 2:1000 in 1% BSA) for 20 min, both at the flow rate of 1 μL min⁻¹. PBS was then flowed through the channel to wash the channel and remove non-specific staining.

Control over the features of microdevices including microfluidic channels is important for the development of analytical devices. We aimed to immobilize cells within microchannels by fabricating PEG microstructures that could facilitate the capture and analysis of cells with control over the adhesion of anchorage dependent cells. To fabricate PEG microstructures, PEGDM was molded beneath a PDMS stamp and subsequently photopolymerized. PEGDM was used due to its ability to crosslink at short exposure times and its low viscosity which allow for its use at high concentrations to fabricate structures with a high aspect ratio.

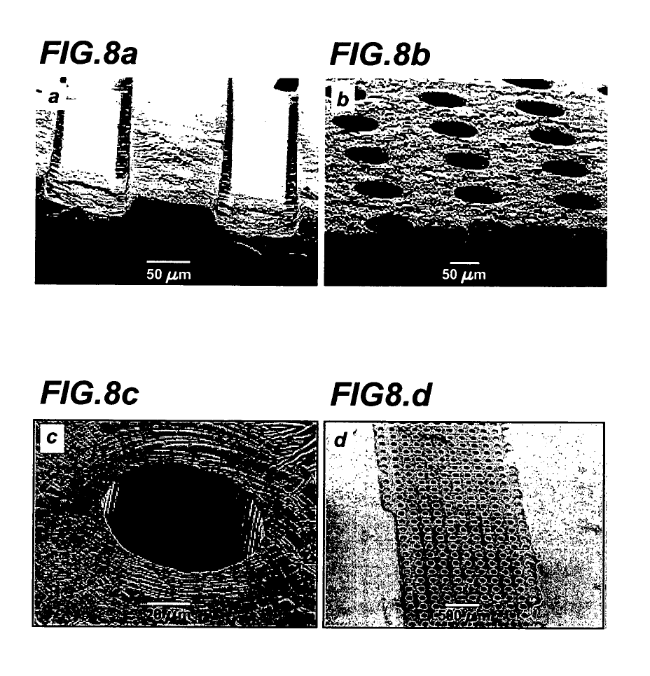

To fabricate microstructures with a non-exposed substrate we molded the polymer onto the features of the PDMS stamp by placing a thick polymer film on the substrate and subsequently placing the stamp on the film (FIG. 7). As shown in FIG. 8a, the microstructures could be generated using this approach without the underlying substrate becoming exposed. Alternatively, to fabricate exposed substrates a layer of PEG was coated onto the PDMS stamp and subsequently molded onto the substrate. These thinner films resulted in the formation of microstructures with exposed substrates (FIG. 8b). The PEG microstructures were ˜25 μm in height with good pattern fidelity (FIG. 8c-d).

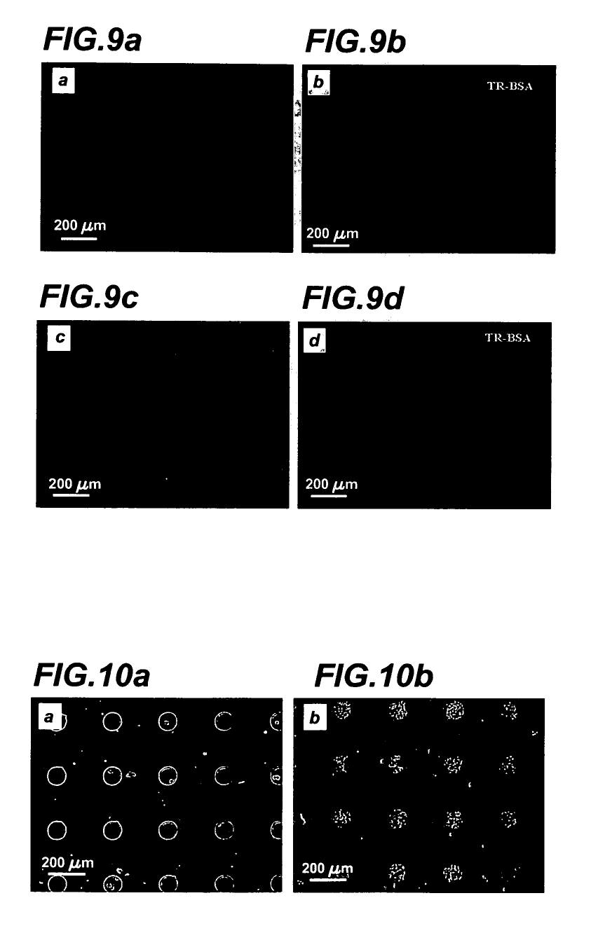

To demonstrate that the approach could be used to generate microstructures with exposed or non-exposed substrates, the ability of the PEG microstructures to resist protein adsorption was examined. Since PEG networks are protein resistant, it is anticipated that for the non-exposed patterns, the patterned regions will resist protein adhesion while for patterns with exposed substrates, proteins will adsorb onto the hydrophobic underlying substrate forming patterned regions. As shown in FIG. 9, microstructure patterns that were treated with TR-BSA could be fabricated either with exposed substrates or without the substrates depending on the fabrication process. Further quantification of the degree of protein adsorption onto the PEG-based microstructures showed that ca. 98% of the protein adsorption was reduced as compared to that of exposed surface of the substrate. In addition, the ability of the exposed substrate to allow for adhesion of cells within the microstructures was examined by dipping the patterned substrates in a solution of FN. After adhesion of the protein onto the substrate the solution was washed and NIH-3T3 cells were seeded on the substrate. After 6 h, the patterns were thoroughly washed to remove all non-adhered cells. As seen in FIG. 10, cells adhered and spread inside microwells with exposed substrates while the cells on the non-exposed microwells were completely washed away even though they had been patterned within the wells.

PEGDM ranging in molecular weight from 330 to 1000 Da was successfully used to fabricate non-biofouling microstructures. However, for the experiments reported here PEGDM 330 and 550 Da were routinely used due to their improved mechanical strength, low swelling properties and ability to resist cells and proteins.

Although it is possible to UV crosslink PEG pre-polymer inside microchannels, the direct crosslinking of the PEG polymer within microfluidic channels has not been shown to generate features with both exposed and non-exposed substrates. Therefore, we hypothesized that the molding of the PDMS stamp on a polymer film would allow for more control over the features of the microfluidic channel.

To fabricate PEG microstructures inside microwells, the microfluidic molds were aligned on substrates that had been pre-patterned with PEG microstructures. To ensure that the microfluidic mold could be irreversibly adhered to the substrate we patterned only a small region of the substrate to allow for plasma treatment of the remainder of the substrate. The PDMS stamp was left undisturbed after molding and the remainder of the substrate was plasma treated to allow for adhesion of the substrate to the PDMS mold.

One of the observations obtained using this approach was the ability of the elastomeric microfluidic mold to seal the channels despite the topographical differences between the patterned region and the surroundings. These microchannels were robust and could stand flow rates of >5 μL min⁻¹. This could be attributed to the elastomeric properties of the mold.

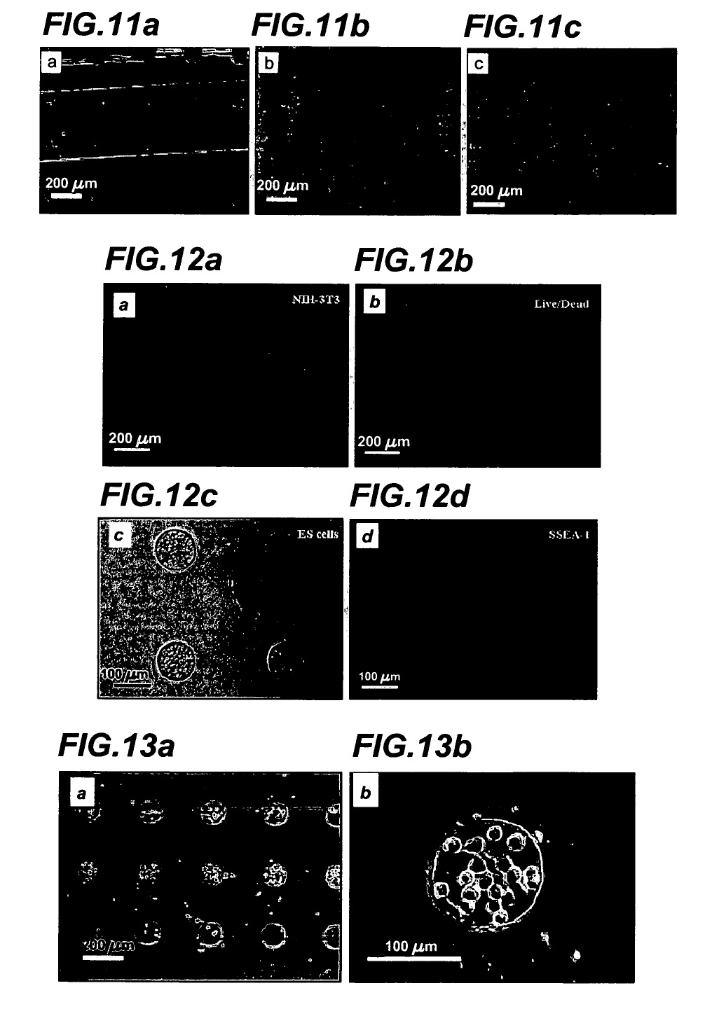

To evaluate the ability of the microstructures within the channels to capture cells, NIH-3T3 and ES cells were used as model cell lines. Both these cells are anchorage dependent and thus they enable testing of the potential adhesion of these cells. In addition, trypsinized cells from both cell types can be used as a model for non-adherent cells. Initial experiments were performed using various shaped features including lanes, grids and circles. Although numerous conditions were tested, two specific conditions facilitated cell docking. In the first approach, the flow rate was tightly regulated to enable flow of the cells inside the channel but was slow enough to allow for a fraction of the cells to be captured by the microstructures. Within standard microchannels (800 μm in width and 80 μm in height) using the parameters used in these experiments, a flow rate of ˜0.3 μL min⁻¹ was found to be optimized in that it allowed for docking of the cells, yet did not clog the tubes due to excessive clumping and aggregation of the cells. However, the optimized flow rate is a function of channel dimensions and geometry (determining shear stress), cell phenotype and concentration. The second approach was to stop the flow briefly to allow for the cells to settle into the microstructures. In general, it took less time with the latter technique to deposit cells within structures and was overall preferred for our subsequent experiments. As shown in FIG. 11, cells successfully docked within features of various shapes. Furthermore, once the cells had settled within these regions, they remained in place and were not washed away even when the flow rate was increased to high values of >5 μL min⁻¹.

To test for the ability of the microchannels to act as potential bioreactors and analytical tools, cells were analyzed using a variety of techniques. To analyze cell viability and the ability to perform enzymatic reactions, ethidium homodimer and calcein AM were allowed to flow through the channel. Ethidium homodimer is a DNA binding dye that stains the membrane of compromised cells. On the other hand, calcein AM is a membrane permeable substrate that is converted within the cells to a green fluorescent molecule that is membrane impermeable. Therefore ‘live’ cells can be visualized as green, while cells with compromised cell membranes show up as red. As expected, ˜98% of NIH-3T3 cells that were immobilized within the channels remained viable based on the expression of the green fluorescent dye. In addition, the cells did not stain red indicating that the membrane integrity had not been compromised during the process (FIG. 12 a-b).

A potential application for immobilizing non-adherent cells within microstructures is to analyze the cells for surface staining of various molecules. To examine the application of the microwells for cell surface staining, ES cells were docked within the channel and subsequently stained for the expression of an undifferentiated stem cell marker, SSEA-1. This was obtained by performing a two-step staining process in which medium containing the SSEA-1 antibody was flowed in the channel followed by a solution containing the secondary antibody, followed by a non-fluorescent medium to wash non-specific binding. As shown in FIG. 12 (c-d), ES cells could be directly stained within the microstructures. Approximately 95% of the cells could be seen expressing SSEA-1, which is similar to the results obtained when the cells are stained and flown through a flow cytometer. These results demonstrate the potential application of this technique to capture cells for a wide range of subsequent applications such as bioreactors and analysis including antibody staining.

As demonstrated earlier, microwells could be generated with exposed substrates that allow for protein adsorption and adhesion of cells. To test the application of this process within microchannels, we generated patterned channels (with exposed substrate) and analyzed the ability of cells to dock and adhere within these wells. FN was allowed to flow through the channels to coat exposed surfaces and promote cell adhesion and spreading. NIH-3T3 fibroblasts were then flowed through the channel and their ability to adhere within the channels was examined using morphological characteristics of the captured cells with time. As expected, cells adhered to the bottom surface of the microwells and elongated within 6 h (FIG. 13). In addition, non-exposed patterns did not promote cell adhesion or elongation using the same experimental conditions.

There are a number of potential advantages associated with this technique for patterning cells within microchannels. For example, both non-adherent and adherent cells can be immobilized, with tight control over the substrate properties while minimizing the effects of shear, therefore widening the potential application of cell-based microdevices. Also, the fabrication process used here is simple and could be applied without the use of masks and special equipment required for photolithography. This fabrication process also has a number of limitations. For example, currently the alignment procedure of the channels on the patterned substrates is facilitated by aligning the PDMS mold on the microstructures. This approach may be cumbersome for complicated patterns that require precise positioning. It is anticipated that the use of micromanipulators could be of benefit in alignment and adhesion of the microfluidic mold with the patterned substrate. Also, there is a potential height barrier for the microstructures since the approach is limited to the elastomeric properties of the PDMS to conform to the height of the polymeric features at the interface of the glass surface and the pattern edge. Therefore, the development of specifically designed patterning stamps that can construct microstructures that can directly fit in the channel may help alleviate this problem.

For further information on the inventions disclosed herein, the reader is directed to “A Soft Lithographic Approach to Fabricate Patterned Microfluidic Channels” by Khademhosseini, A. et al., Analytical Chemistry, Volume 76, Number 13, Jul. 1, 2004 and “Molded Polyethylene Glycol Microstructures for Capturing Cells within Microfluidic Channels” by Khademhosseini, A. et al., Lab Chip, 2004, 4, 425-430, the entire contents of both of which are incorporated herein by reference.

It is recognized that modifications and variations of the inventions disclosed herein will be apparent to those of ordinary skill in the art and it is intended that all such modifications and variations be included within the scope of the appended claims.

What is claimed is:

1. Microfluidic channel comprising:
a microfluidic mold defining a channel; and
a substrate including patterned regions, wherein the microfluidic mold is in conformal contact with the substrate to form an irreversible seal.

2. The channel of claim 1 wherein the patterned regions comprise polymeric regions in the range of 1-500 nanometers in height.

3. The channel of claim 1 wherein the patterned regions comprise microstructures adapted to capture and immobilize cells and other biological species such as viruses and bacteria.

4. The channel of claim 3 wherein the patterned regions are exposed to the substrate.

5. The channel of claim 3 wherein the patterned regions are not exposed to the substrate.

6. The channel of claim 1 wherein the patterned regions are formed of non-biofouling PEG-based copolymer.

7. The channel of claim 1 wherein the patterned regions are formed of hyaluronic acid.

8. The channel of claim 6 wherein the PEG-based polymer is poly(TMSMA-r-PEGMA).

9. The channel of claim 3 wherein the microstructures have a height in the range of 0.1-50 μm.

10. The channel of claim 3 wherein the microstructures provide shear protection for the cells.

11. Method of making a patterned microfluidic channel comprising:
coating a substrate with a polymer;
conformal contacting a patterned stamp with the polymer coated substrate to create a patterned substrate;
treating exposed regions of a substrate with oxygen plasma;
removing the patterned stamp; and
positioning a microfluidic channel on the patterned substrate so that it is covalently bonded to the substrate.

12. Method for making a patterned microfluidic channel comprising:
coating a patterned stamp with a polymer;
conformal contacting the coated patterned stamp with a substrate to create a patterned substrate;
treating exposed regions of the substrate with oxygen plasma;
removing the patterned stamp; and
positioning a microfluidic channel on the patterned substrate so that it is covalently bonded to the substrate.

13. Method for making microstructures inside microchannels comprising:
spreading a pre-polymer solution on a substrate;
contacting a patterned stamp onto the substrate;
crosslinking the pre-polymer solution;
cleaning the substrate beyond the patterned stamp;
removing the patterned stamp leaving patterns that do not expose the substrate; and
aligning a microfluidic mold on the patterned substrate to create a microfluidic channel.

14. Method for making microstructures inside microchannels comprising:
spreading a pre-polymer solution on a patterned stamp;
contacting the stamp onto a substrate;
crosslinking the pre-polymer solution;
cleaning the substrate beyond the patterned stamp;
removing the patterned stamp leaving patterns that expose the substrate; and
aligning a microfluidic mold on the patterned substrate to create a microfluidic channel.

15. The microfluidic channel of claim 1 wherein the substrate is selected from the group consisting of glass, SiO₂, polystyrene, Si wafers, and other metal oxide-based substrates.

16. The microfluidic channel of claim 1 wherein the mold is PDMS.

17. Method of using the microfluidic channel of claim 1 comprising introducing cells into the channel.
